(19) United States
(12) Patent Application Publication
(10) Pub. No.: US 2024/0418484 A1
(43) Pub. Date: Dec. 19, 2024

(54) Wadding for a shot or bullet cartridge, shot or bullet cartridge comprising such a wadding, and methods for producing said wadding and said cartridge

(71) Applicant: DECATHLON, VILLENEUVE D'ASCQ (FR)

(72) Inventor: Clément DUBORPER, VILLENEUVE D'ASCQ (FR)

(21) Appl. No.: 18/741,869

(22) Filed: Jun. 13, 2024

(30) Foreign Application Priority Data
Jun. 15, 2023 (FR) 2306118

(51) Int. Cl. F42B 7/08; C08K 9/04; F42B 33/00

(52) U.S. Cl. CPC F42B 7/08; C08K 9/04; F42B 33/001

(57) ABSTRACT

The present application relates to an at least partially biodegradable wadding for a shot or bullet cartridge made of a single plastic piece, said wadding comprising one or more polymer(s) including one or more polybutylene succinate polymer(s) and calcium carbonate. The mass fraction of said one or more polymer(s) in said wadding is greater than or equal to 70%, the mass fraction of calcium carbonate in said wadding is greater than or equal to 6.5%, and the one or more polybutylene succinate polymer(s) is/are the majority by mass in said wadding.

### TECHNICAL FIELD

The present application relates to the technical field of partially or totally biodegradable waddings for shot or bullet cartridges, used in particular for shot or bullet weapons, for example used for hunting or recreational shooting.

The present application also relates to the technical field of shot or bullet cartridges comprising such waddings.

The present application also relates to the methods for producing partially or totally biodegradable waddings for a shot or bullet cartridge, and shot or bullet cartridges comprising such waddings.

### PRIOR ART

A wadding for a cartridge is generally housed in the interior volume of the casing of a shot or bullet cartridge for example, and separates the projectile(s), for example the shot or the lead balls or the bullet from the propellant powder.

During firing, the wadding transmits the energy induced by the thrust of the propellant powder combustion gases to the projectile(s). The wadding must then ensure an efficient and regular thrust, and do so in a reproducible manner.

The wadding has, among its various functions, a piston function, and is subject to a very large pressure during firing, for example being able to reach more than 1000 bar, over several hundred microseconds.

Thus, the wadding must not break or crack in the lumen of the firearm, in order to avoid obstructing said lumen. For safety reasons, it is thus desired that the wadding remains intact during firing, and after firing during its trajectory in the lumen (or the barrel) of the weapon and after its expulsion from the weapon. Premature breaking of the wadding causes gas leaks and thus a loss of thrust pressure.

During firing, the wadding is thus released into the environment, sometimes as several scattered pieces of debris. Materials are therefore sought which are able to degrade in the environment under the effect of microorganisms and/or low temperatures, for example at temperatures less than or equal to approximately 30° C.-40° C., and/or under the effect of water. It is also desired that these materials can guarantee the ballistic performance ensured for a conventional non-biodegradable wadding, and are sufficiently resistant to guarantee compliance with the safety standards of users.

The following documents describing biodegradable waddings are known.

EP 3.601.937 A1 describes a two-part wadding, the first part receiving the propellant powder and the second part receiving the one or more projectiles. The first and second parts are made of various biodegradable polyesters in the examples, the first part comprising PBSA and the second part comprising PHA. The wadding being in two distinct parts, this implies a production method with several steps, which is therefore longer and more expensive.

EP 3 290 858 B1 also describes a wadding comprising a biodegradable polyester, such as PLA, optionally in a mixture with a biodegradable elastomer, such as polycaprolactone or PBS, with calcium carbonate. The mass fraction of calcium carbonate is low and described as being at most 5%.

Lactic acid-based polymers are not satisfactory, because they are difficult to use in a plastics transformation method (for example by injection). Moreover, the waddings obtained break easily.

EP 1 877 721 A1 describes a wadding obtained by injection of a mixture comprising 50% to 67% by mass of PVA, 20% to 30% of a filler, for example calcium carbonate, 15% to 17% of a glycerine-based plasticiser and propylene glycol, and 1% to 2% of a binder.

However, the biodegradable waddings of the prior art are not satisfactory and encounter many problems.

Many waddings are made of biodegradable polymers which are water soluble (for example, PVA or PHA) and therefore sensitive to humidity. Their properties can thus be altered under the usual storage conditions of waddings for cartridges. Waddings made of biodegradable polymers that are sensitive to humidity must thus be produced under particular humidity conditions, then bagged in a waterproof bag after their production. The waterproof bags increase the quantity of plastic material used. Moreover, the production method is more expensive and complex to implement, since it is necessary to control the level of humidity and to invest in bagging machines. Non-plastic biodegradable waddings based on cellulose materials such as cardboard also exist. Nevertheless, cardboard is also sensitive to humidity, the properties of the cellulose can therefore degrade during storage. Moreover, it is necessary to invest in specific machines for producing such cardboard waddings.

Finally, biodegradable waddings produced from biodegradable polymers do not offer satisfactory mechanical performance, for example they break or crack during firing, and do not therefore correctly ensure their piston function. The firings are also not regular. The use of biodegradable polymers in plastic transformation processes for developing specific waddings is also complex with long transformation times (for example injection times).

Moreover, the biodegradable polymers are in contact with the projectile(s) for a prolonged period and must not therefore impact negatively on the ballistic properties of the one or more projectiles.

Finally, certain biodegradable polymers are too expensive to be used profitably in waddings for cartridges.

The present application thus aims to provide waddings for a shot or bullet cartridge for which the production method is simplified, which are easily storable for a long duration (for example from approximately 6 months to 2 years) without loss of their properties, ensuring regular shots and good mechanical performance, at low cost, and finally being biodegradable under specific conditions, in other words at low temperatures and/under the effect of microorganisms present in the environment, while limiting their environmental impact.

### DISCLOSURE

The object of the present application, according to a first aspect, is an at least partially biodegradable wadding for a shot or bullet cartridge overcoming the above-mentioned problems in that it comprises: a first portion comprising an open end and comprising a first recess arranged to receive a determined volume of projectile(s), and a second portion comprising an open end and comprising a second recess arranged to receive a determined volume of at least one propellant charge.

Advantageously, said wadding is a single plastic piece, said wadding comprising one or more polymers including one or more polybutylene succinate polymers, said wadding comprising calcium carbonate, and the mass fraction of said one or more polymers in said wadding is greater than or equal to 70%, and the mass fraction of calcium carbonate in said wadding is greater than or equal to 6.5%, and the one or more polybutylene succinate polymers is, or are, the majority by mass in said wadding.

Advantageously, the wadding according to the application meets the criteria set out in the standards decreed by the CIP (Commission Internationale Permanente pour l'Epreuve des Armes à Feu Portatives [Permanent International Commission for the Proof of Small Arms]), and are at least partially biodegradable, and have good firing performance: standard deviation in firing velocity of order 6 m/s, deviation in pressure measured during firing of approximately 60 bar, and regular velocity during a firing measured as at least 410 m/s.

Moreover, the wadding according to the application does not require storage under particular conditions of humidity, and thus does not require bagging in order to preserve its properties.

Advantageously, the duration of the injection moulding cycle of the wadding according to the application is reduced, which improves the productivity of the method for producing said wadding.

The inventors have thus surprisingly found that the combination of calcium carbonate, present as at least 6.5% by mass in the wadding, with polybutylene succinate present as the majority of the polymer(s), in particular representing at least 70% by mass of the wadding, can reduce the injection time of the wadding by at least 30%, and improve the regularity of the firings in terms of reducing the standard deviation of velocity and pressure measured during test firings.

When the mass fraction of calcium carbonate exceeds 30%, the standard deviation of velocity and pressure increases, and the regularity of firings thus deteriorates by approximately 10%.

When the mass fraction of calcium carbonate is less than 6.5%, no improvement is observed in the reduction of the standard deviations in the velocity and pressure compared with a control wadding without calcium carbonate.

Advantageously, the wadding according to the application is biodegradable in the environment under the effect of microorganisms and at ambient temperature.

The biodegradation tests carried out on the wadding according to the application when buried in soil show a biodegradation of at least 90% after more than 150 days, and under the effect of water show a biodegradation of at least 90% after more than 84 days.

In an embodiment, at least 50% by mass of the wadding is biodegradable, more preferably at least 60% or at least 70% by mass, or at least 80% by mass of the wadding is biodegradable, more preferably at least 90% by mass of the wadding is biodegradable.

Preferably, the one or more polymers that comprise the wadding is/are biodegradable, in particular polybutylene succinate is biodegradable.

Advantageously, polybutylene succinate is a biodegradable aliphatic polyester.

Advantageously, poly(butylene succinate (PBS), also called poly(tetramethylene succinate), is a thermoplastic polymer formed by polymerisation of succinic acid, or of at least one succinic acid diester, such as dimethyl succinate, with 1,4-butanediol.

Advantageously, calcium carbonate is biodegradable.

Calcium carbonate (CaCO₃) is advantageously composed of carbonate irons (CO₃²⁻) and calcium ions (Ca²⁺).

The biodegradability, in particular in soil under aerobic conditions, can be measured using the following standards:
ISO 17556, entitled “Plastics-Determination of the ultimate aerobic biodegradability in soil by measuring the oxygen demand in a respirometer or the amount of carbon dioxide released”, dating from 2019;
ISO 11266, entitled “Soil quality-Guidance on laboratory testing for biodegradation of organic chemicals in soil under aerobic conditions”, dating from 1994;
ASTM D5988, entitled “Standard Test Method for Determining the Aerobic Biodegradation of Plastic Materials in Soil”, dating from 2018.

The biodegradability in soil under aerobic conditions is preferably measured using standard ISO 17556 cited above, and dating from 2019. Preferably, the test conditions are as follows: the control item is made of cellulose powder, the wadding tested is reduced in size (cryogenic grinding); the incubation temperature is held at 25° C.+/−2° C. and the test lasts for 4 months. The duration of the test can be increased depending on the intended purpose.

The biodegradability in an aqueous medium is preferably determined using standard ISO 14851 entitled “Determination of the ultimate aerobic biodegradability of plastic materials in an aqueous medium—Method by measuring the oxygen demand in a closed respirometer”, dating from 2019.

The biodegradability of the wadding or of a polymer or in general of any component used in the wadding according to the application can be determined by standard ISO 14851, dating from 2019, or by standard ISO 17556, dating from 2019.

The propellant powder is in the form of solid particles, for example is a flake propellant powder or a tubular propulsive powder.

Preferably, the first portion is in the form of an elongate cup.

Preferably, the second portion is in the form of a cup.

Advantageously, the open end of the first portion opens directly into the first recess, and the open end of the second portion opens directly into the second recess.

Advantageously, the first portion has a substantially cylindrical general shape.

Advantageously, the second portion has a substantially cylindrical general shape.

Advantageously, the first recess comprises an open end and a bottom.

Advantageously, the second recess comprises an open end and a bottom.

Advantageously, the bottom of the second recess is substantially opposite the bottom of the first recess.

Advantageously, the wadding comprises a longitudinal axis L, and the first and second portions extend along the longitudinal axis.

Advantageously, the wadding is composed of first and second portions, and a separation wall separating said first and second portions.

Advantageously, the bottom of the first portion and the bottom of the second portion are separated by a separation wall, in particular having a thickness greater than or equal to 2.00 mm. More particularly, the separation wall is solid.

Advantageously, the first and second portions are aligned along the longitudinal axis of the wadding.

Advantageously, the central axis of symmetry of the first portion is coincident with the central axis of symmetry of the second portion, the central axis of symmetry being parallel to the longitudinal axis of the wadding.

Advantageously, the wadding is a single plastic piece and is therefore obtained by hot moulding of a plastic mixture, in particular comprising one or more polymers in a mixture with at least calcium carbonate, for example by injection (moulding).

Advantageously, the wadding is a single piece of plastic.

Advantageously, the production method of the wadding is simple and therefore the wadding is inexpensive. Moreover, there is no problem of resistance to delamination between two parts of the wadding which would be joined together.

Advantageously, the wadding does not include any other part.

### Definitions

In the present text, the term “biodegradable” shall mean any material (for example: the wadding, a biodegradable polymer . . . ) capable of degrading/decomposing in a natural environment (for example: the forest) under the effect of microorganisms (bacteria, fungi, algae, etc.) and/or ambient heat, optionally in combination with water. Advantageously, the result of this decomposition is the formation of water, CO2 and/or methane and optionally by-products (residues, new biomass, etc.) that are not harmful to the environment.

In the present text, the term “polymer” shall mean any homopolymer or copolymer composed of at least two different monomers.

In the present text, the term “at least partially biodegradable” shall mean that the wadding is totally or partially biodegradable.

In the present text, the term “Dx value” shall mean that x % by mass of the particles (in particular of the powder) of calcium carbonate (optionally surface treated) have a size less than the Dx value, and that (100−x) % by mass of these particles have a size greater than said value. The size of the particles is preferably determined by a Mastersizer 2000 laser particle size analyser (Malvern Instrument).

The term “polybutylene succinate polymer(s)” is understood to mean that the wadding or the mixture i) from the method for producing the wadding can comprise a polymer of polybutylene succinate or several different polybutylene succinate polymers.

In the present text, the term “surface treated calcium carbonate” shall mean that the particles of calcium carbonate have been surface treated with a determined mixture, in particular an acid-based mixture as described in the present text.

In the present text, the expression “a polybutylene succinate polymer is the majority by mass in the wadding” shall mean that the mass fraction of this polybutylene succinate polymer in the wadding is the highest mass fraction compared with the mass fractions of the other components constituting the wadding.

In the present text, the expression “polybutylene succinate polymers are the majority by mass in the wadding” shall mean that the mass fraction of these polybutylene succinate polymers in the wadding is the highest mass fraction compared with the mass fractions of the other components constituting the wadding.

In the present text, the term “projectile(s)”, shall mean shot or lead shot or even a bullet.

In the present text, the term “plastic piece” shall mean that said piece is based on one or more thermoplastic polymers, in other words this or these polymers represent at least 50% by mass, preferably at least 60% or 70% by mass, of said plastic piece.

The mass fraction of one or more components (for example polymer or calcium carbonate) in said wadding is calculated as being the ratio of the mass of said one or more components over the total mass of said wadding, multiplied by 100.

In the present text, the term “propellant charge” shall mean any type of propellant powder selected so that its combustion causes a strong discharge of gas, the pressure of which expels the wadding from the weapon.

The wadding according to the application may comprise one or more components other than calcium carbonate and polybutylene succinate polymer(s), such as one or more pigments, or even one or more thermoplastic biodegradable polymers (in particular polyester), for example PLA (polylactic acid) or PBSA, but for which the mass fraction is less than or equal to 15%, in particular less than or equal to 10%, in the wadding.

In an embodiment, the mass fraction of calcium carbonate and of polybutylene(s) succinate(s) in the wadding is greater than or equal to 80%, more preferably greater than or equal to 85%, preferably greater than or equal to 90% or to 95%.

In an embodiment, the one or more polymer(s) which comprise the wadding, in particular the one or more polybutylene succinate polymer(s) which comprise the wadding, have (in particular each has) at least one of the properties chosen independently among the following properties:
a density (g/cm³) greater than or equal to 1.10 and less than or equal to 1.30, in particular greater than or equal to 1.20 and less than or equal to 1.30, in particular measured using standard ISO 1183 (in particular of April 2019); and/or
a melt flow rate (MFR: Melt Flow Rate) measured at 190° C., under a load of 2.16 kg, in particular using standard ISO 1133 (in particular of 2011), greater than or equal to 1 g/10 min and less than or equal to 10 g/10 min, in particular greater than or equal to 2 g/10 min and less than or equal to 6 g/10 min; and/or
a melting temperature greater than or equal to 60° C. and less than or equal to 100° C., in particular ranging from 80° C. to 90° C., in particular measured using standard ISO 3146 (in particular of 2022); and/or
an elongation at break measured using standard ISO 527-2 (%) (in particular of 2022) greater than or equal to 200%, in particular greater than or equal to 250% or greater than or equal to 300%, more particularly greater than or equal to 350%, in particular less than or equal to 600%;
a flexural modulus (MPa) measured using standard ISO 178 (in particular of 2019) less than or equal to 400 MPa, in particular greater than or equal to 100 MPa, more particularly less than or equal to 300 MPa, still more particularly greater than or equal to 200 MPa; and/or
an impact resistance Izod at 23° C. (kJ/m²) measured using standard ISO 180 (in particular of 2019) greater than or equal to 20 kJ/m², preferably greater than or equal to 30 kJ/m² or to 40 kJ/m², in particular less than or equal to 80 kJ/m²; and/or
a Rockwell hardness (R Scale) measured using standard ISO 2039-2 (in particular of 1987) greater than or equal to 30 and less than or equal to 100, preferably less than or equal to 80, more preferably less than or equal to 70 and greater than or equal to 40. Preferably, the calcium carbonate is chosen from ground calcium carbonates (for example originating from marble, limestone, dolomite and/or chalk) and/or precipitated calcium carbonates (for example valerite, calcite and/or aragonite) and/or calcium carbonates treated by surface reaction (in particular referred to, in the present text, as surface treated calcium carbonates), and/or in the mixtures thereof.

Preferably, at least 55% by number of calcium carbonate particles have a size less than or equal to 2 μm.

The waddings according to the application must comply with the standards decreed by the CIP relating to safety (Commission Internationale Permanente pour l'Epreuve des Armes à Feu Portatives). This commission legislates, in particular in France, on the safety standards for munitions and firearms.

Advantageously, the wadding according to the application is suitable for a shot or bullet cartridge.

In a non-limiting manner, a shot or bullet cartridge can be used with a hunting or sport shooting rifle, or even a semi-automatic rifle, but also in other types of weapons, such as smooth or rifled bore weapons.

Advantageously, the wadding has the function of cleaning the lumen of the firearm at each firing, and of ensuring a uniform thrust on the base of the one or more projectiles. Advantageously, the wadding is an intermediate member disposed between a propellant powder and the one or more projectiles.

Advantageously, the wadding is a skirt-type wadding.

In an alternative embodiment, the calcium carbonate comprises, or is, a calcium carbonate surface treated with a mixture of one or more polycarboxylic acid(s) and/or one or more acid anhydride(s) of said one or more polycarboxylic acid(s), and/or one or more salt(s) of said one or more polycarboxylic acid(s) and/or one or more salt(s) of said one or more acid anhydride(s).

In an embodiment, the calcium carbonate comprises, or is, a calcium carbonate surface treated by at least one monosubstituted succinic anhydride and/or at least one aliphatic, linear or branched carboxylic acid, and/or one of the salts thereof, comprising 8 to 24 carbon atoms, preferably stearic acid, more preferably stearic acid at a level of at least 10% by mass.

For example, the calcium carbonate can be surface treated with succinic anhydride and with a stearic acid:palmitic acid, 1:1, mixture.

In an alternative embodiment, the calcium carbonate comprises, or is, surface treated calcium carbonate, in particular as described in the present text, in a mixture with one or more at least partially biodegradable support polymer(s), for example one or more aliphatic polyester(s), such as polybutylene adipate terephthalate (PBAT), polylactic acid (PLA) or even polybutylene succinate (PBS) and the mixtures thereof, in particular so as to form a calcium carbonate based primary compound in which the calcium carbonate, in particular the surface treated calcium carbonate, represents at least 65% by mass of said calcium carbonate based primary compound and/or the one or more support polymer(s) represent at most 35% by mass of said calcium carbonate based primary compound.

In particular, the one or more support polymer(s) enter into the calculation of the mass fraction of polymer(s) of said wadding.

In an alternative embodiment, the wadding comprises a primary compound comprising said, in particular surface treated, calcium carbonate.

Preferably, the wadding comprises at least 10% by mass, and at most 30% by mass of said primary compound.

The primary compound is as described in the present text.

In particular, the primary compound comprises at least 50%, or at least 60%, by mass of, in particular surface treated, calcium carbonate, and one or more biodegradable polymer(s), in particular for which the mass fraction in said primary compound is greater than or equal to 5% and less than or equal to 40%, more particularly greater than or equal to 20% and less than or equal to 40%.

In an alternative embodiment, the optionally surface treated calcium carbonate comprises, or is, calcium carbonate comprising 40% to 70% by mass, preferably 50% to 60% by mass, of particles for which D₅₀ is less than or equal to 2 μm.

In an alternative embodiment, the optionally surface treated calcium carbonate comprises, or is, calcium carbonate for which D₅₀ is greater than or equal to 0.1 μm and less than or equal to 7 μm, preferably greater than or equal to 0.5 μm and less than or equal to 4 μm.

In an alternative embodiment, the optionally surface treated calcium carbonate, comprises, or is, calcium carbonate for which D₉₈ is less than or equal to 50 μm, preferably less than or equal to 40 μm, more preferably less than or equal to 15 μm. In an alternative embodiment, the optionally surface treated calcium carbonate comprises, or is, calcium carbonate for which the (BET) specific surface area is greater than or equal to 0.5 and less than or equal to 150 m² per gram of calcium carbonate. The (BET) specific surface area is preferably determined using standard ISO 9277:2022 entitled “Determination of the Specific Surface Area of Solids by Gas Adsorption-BET Method”.

In an alternative embodiment, the mass fraction of optionally surface treated calcium carbonate in the wadding is greater than or equal to 9.5% and less than or equal to 20%, preferably less than or equal to 16.5%, in particular is of order 13%+/−3%. The inventors have determined that this interval makes it possible to obtain a reduced standard deviation of the velocity V1 during firing, in particular of order 5-6 metres/second (m/s).

In an alternative embodiment, the wadding is an injection moulded part, in particular the bottom of the first portion of the wadding is the area of ejection from the mould and/or the bottom of the second portion of the wadding is the area of the injection point.

In an alternative embodiment, the mass fraction of polymer(s), in particular polybutylene succinate polymer(s), is greater than or equal to 70% and less than or equal to 95%, in particular greater than or equal to 80% and less than or equal to 95%, more particularly less than or equal to 90%.

Advantageously, the one or more polymers is/are one or more aliphatic and/or aromatic polyesters, preferably an aliphatic polyester.

Advantageously, the one or more polymers is/are biodegradable.

In an alternative embodiment, the polybutylene succinate polymer represents at least 70% by mass of the wadding, preferably at least 80% by mass of the wadding, more preferably at least 90% by mass of the wadding.

In an alternative embodiment, the wadding has a density ranging from 1.20 g/cm³ to 1.50 g/cm³.

In an alternative embodiment, the first portion of the wadding is a skirt comprising longitudinal slots, in particular comprising 2 to 6 longitudinal slots, more particularly 3 to 5 longitudinal slots, for example 4 longitudinal slots.

Advantageously, the longitudinal slots are open at the open end of the first portion of the wadding.

Advantageously, the longitudinal slots extend from the open end of the first portion of the wadding, in other words from its distal portion, to its proximal portion, and extend over at least 50% of the height, in particular over at least ⅔ of the height, of the first portion of the wadding.

In an alternative embodiment, the first portion of the wadding comprises a proximal portion and a distal portion, and the thickness of the wall of the first portion is decreasing from its proximal portion towards its distal portion.

Preferably, the wall of the first portion is a radial wall.

In an alternative embodiment, the second portion of the wadding comprises a proximal portion and a distal portion, and the thickness of the wall of the second portion is substantially constant from its proximal portion towards its distal portion.

Preferably, the wall of the second portion is a radial wall.

In an alternative embodiment, the wadding comprises a separation wall separating a bottom of the first portion of the wadding from the bottom of the second portion of the wadding, said separation wall having a thickness greater than or equal to 2.00 mm.

Advantageously, said separation wall is solid.

In an alternative, the height of the first portion of the wadding is greater than or equal to 5 times the height of the second portion of the wadding.

Preferably, the height of the first portion of the wadding is greater than or equal to 20 mm, more preferably greater than or equal to 30 mm, in particular less than or equal to 60 mm, for example 33 mm+/−3 mm.

Preferably, the height of the second portion of the wadding is greater than or equal to 2 mm, more preferably greater than or equal to 4 mm, in particular less than or equal to 10 mm, for example 5.50 mm+/−1 mm.

An object of the present application, according to a second aspect, is a shot or bullet cartridge comprising an at least partially biodegradable wadding for a shot or bullet cartridge according to any of the alternative embodiments with reference to the first aspect of the application.

The shot or bullet cartridge must satisfy the above-cited rules set out by the CIP.

The cartridge is suitable for a portable shot or bullet weapon; by way of non-limiting examples, for the following portable weapons: hunting or sport shooting rifle, semi-automatic rifle, or can be used in other types of weapons, such as smooth or rifled bore weapons.

An object of the present application, according to a third aspect, is a method for producing an at least partially biodegradable wadding for a shot or bullet cartridge comprising the following steps:
i) preparing a mixture comprising one or more polymer(s) including one or more polybutylene succinate polymer(s), and further comprising a primary compound comprising calcium carbonate, the mass fraction of said one or more polymers in said mixture is greater than or equal to 70%, the mass fraction of calcium carbonate in said mixture is greater than or equal to 6.5%, and the one or more polybutylene succinate polymer(s) is/are the majority by mass in said mixture;
ii) heating said mixture originating from step i) in a single moulding step for moulding a primary wadding for a shot or bullet cartridge with a mould set comprising an imprint of the primary wadding for a shot or bullet cartridge;
iii) recovering the primary wadding for a cartridge moulded in said mixture;
optionally a step iv) of preparing one or more longitudinal slots in a first portion of the wadding for a cartridge,
in particular recovering the finished wadding for a cartridge.

Preferably, step iv) of preparing one or more longitudinal slots comprises cutting said one or more slots in the first portion.

Preferably, step ii) comprises heating the mixture on an extruder comprising an extrusion screw having a plurality of distinct heating zones, with one or more zones having a heating temperature preferably greater than or equal to 150° C. and less than or equal to 220° C., in particular ranging from 170° C. to 200° C.

Preferably, step ii) is an extrusion-moulding step and/or an injection moulding step.

In an alternative embodiment, the one or more polybutylene(s) succinate(s) represent(s) at least 70% by mass of said mixture of step i), preferably at least 80% by mass of said mixture of step i), in particular at most 90% by mass of said mixture of step i).

In an alternative embodiment, the calcium carbonate represents at least 6.5%, or at least 9.5%, by mass of said mixture of step i), preferably at most 20% by mass of the mixture of step i), more preferably at most 16.5% by mass of said mixture of step i).

In an alternative embodiment, the calcium carbonate of the primary compound comprises, or is, calcium carbonate surface treated with a mixture (poly) carboxylic(s) acid(s) and/or one or more acid(s) anhydride(s) of said one or more (poly) carboxylic(s) acid(s), and/or one or more salt(s) of said one or more (poly) carboxylic(s) acid(s) and/or one or more salt(s) of said one or more acid(s) anhydride(s), and the primary compound comprises one or more biodegradable polymer(s) mixture(s) with said calcium carbonate.

The alternative embodiments relating to the description of the calcium carbonate with reference to the first aspect of the application apply to the calcium carbonate used in the method for producing the wadding according to a third aspect of the application.

In an alternative embodiment, the mass fraction of, in particular surface treated, calcium carbonate in the primary compound is greater than or equal to 50%, preferably greater than or equal to 65%, in particular less than or equal to 90%, in particular of order 65%+/−5%.

In an alternative embodiment, the mass fraction of at least partially biodegradable support polymer(s) in the primary compound, said one or more support polymer(s) being in a mixture with the (optionally surface treated) calcium carbonate, is greater than or equal to 5% and less than or equal to 40%, in particular greater than or equal to 20%, in particular of order 35%+/−5%.

In an alternative embodiment, the mass fraction of at least partially biodegradable support polymer(s) in the mixture of step i) is greater than 0%, in particular greater than or equal to approximately 3.5%, and less than or equal to 15%, in particular less than or equal to 10.5%, for example of order 7.5%+/−3%.

In an alternative embodiment, the bulk density of the primary compound comprising calcium carbonate is greater than or equal to 1.5 g/cm³ and less than or equal to 1.8 g/cm³, in particular greater than or equal to 1.6 g/cm³ and less than or equal to 1.7 g/cm³.

In an alternative embodiment, the primary compound has a melt flow rate greater than or equal to 5 g/10 min, in particular greater than or equal to 7 g/10 min and less than or equal to 20 g/10 min, measured at a temperature of 190° C., under a mass of 2.16 kg, and in accordance with standard ISO 1133-1, in particular dating from 2011.

Preferably, the melt flow rate is greater than or equal to 7 g/10 min and less than or equal to 17 g/10 min, in particular greater than or equal to 8 g/10 min and less than or equal to 15 g/10 min.

In an alternative embodiment, at least one of the polybutylene(s) succinate(s), or each of the polybutylenes succinates, has a tensile modulus measured in the machine direction on an extruded blown film of thickness 20 μm using standard ISO 527-3:2018 greater than or equal to 200 MPa.

In an alternative embodiment, at least one of the polybutylene(s) succinate(s), or each of the polybutylenes succinates, has a melt flow rate greater than or equal to 1 g/10 min and less than or equal to 10 g/10 min, in particular greater than or equal to 2 g/10 min and less than or equal to 6 g/10 min, measured at a temperature of 190° C., under a mass of 2.16 kg, and in accordance with standard ISO 1133-1, in particular dating from 2011.

In particular, standard ISO 1133-1, in particular dating from 2011, is entitled “Plastics—Determination of the Melt Mass-Flow Rate (MFR) and Melt Volume-Flow Rate (MVR) of Thermoplastics—Part 1: Standard Method”.

Preferably, the one or more polybutylene succinate polymer(s) have at least one of the properties chosen independently among the following properties:
a density (g/cm³) greater than or equal to 1.10 and less than or equal to 1.30, in particular greater than or equal to 1.20 and less than or equal to 1.30, in particular measured using standard ISO 1183 (in particular of April 2019); and/or
a melt flow rate (MFR: Melt Flow Rate) measured at 190° C., under a load of 2.16 kg, in particular using standard ISO 1133 (in particular of 2011), greater than or equal to 1 g/10 min and less than or equal to 10 g/10 min, in particular greater than or equal to 2 g/10 min and less than or equal to 6 g/10 min; and/or
a melting temperature greater than or equal to 60° C. and less than or equal to 100° C., in particular ranging from 80° C. to 90° C., in particular measured using standard ISO 3146 (in particular of 2022); and/or
an elongation at break measured using standard ISO 527-2 (%) (in particular of 2022) greater than or equal to 200%, in particular greater than or equal to 250% or greater than or equal to 300%, more particularly greater than or equal to 350%, in particular less than or equal to 600%;
a flexural modulus (MPa) measured using standard ISO 178 (in particular of 2019) less than or equal to 400 MPa, in particular greater than or equal to 100 MPa, more particularly less than or equal to 300 MPa, still more particularly greater than or equal to 200 MPa; and/or
an impact resistance Izod at 23° C. (kJ/m²) measured using standard ISO 180 greater (in particular of 2019) than or equal to 20 kJ/m², preferably greater than or equal to 30 kJ/m² or to 40 kJ/m², in particular less than or equal to 80 kJ/m²; and/or
a Rockwell hardness (R Scale) measured using standard ISO 2039-2 (in particular of 1987) greater than or equal to 30 and less than or equal to 100, preferably less than or equal to 80, more preferably less than or equal to 70 and greater than or equal to 40.

An object of the present application, according to a fourth aspect, is a method for producing a shot or bullet cartridge according to a second aspect of the application, comprising the following steps:
providing a wadding for a shot or bullet cartridge according to any one of the alternative embodiments with reference to the first aspect of the application and of a cartridge comprising a casing, said casing comprising a primer,
placing a determined volume of a propellant charge inside the casing,
placing the wadding for a shot or bullet cartridge in the casing,
placing one or more projectile(s) in the casing,
crimping the cartridge, and
recovering the cartridge obtained.

The features and alternative embodiment with reference to the first aspect of the application can be independently combined with one another, and with any of the alternative embodiment with reference to the second aspect or the third aspect or the fourth aspect of the application.

### DESCRIPTION OF THE DRAWINGS

The application will be better understood upon reading the following description of embodiments of the application, given solely as non-limiting examples and with reference to the attached drawings, wherein:

FIG. 1 is a schematic representation in longitudinal section of a first example of a shot cartridge according to the application;

FIG. 2 schematically represents the wadding represented in FIG. 1.

### DESCRIPTION OF THE EMBODIMENTS

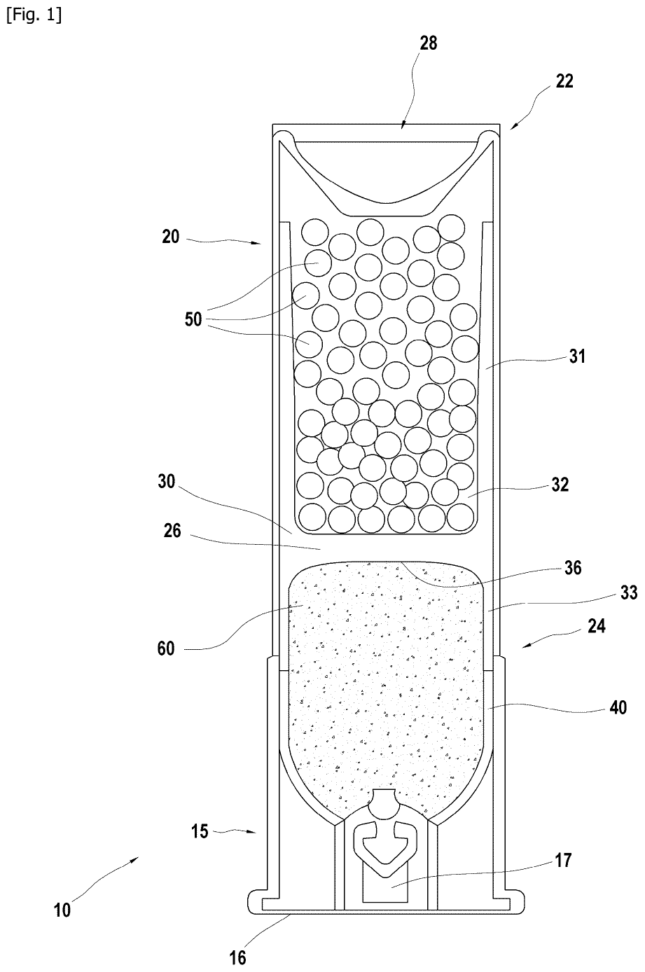

The cartridge 10 represented in FIG. 1 comprises a casing 20 having a distal end 22 and a proximal end 24, said casing 20 receiving in its interior volume 26 a wadding 30 according to the application. The cartridge 10 further comprises a base 15 and a primer 17 mounted on the bottom 16 of the base 15. The base 15 is mounted on the open proximal end 24 of the casing 20 and closes it. The cartridge 10 comprises a reinforcement 40 in the form of an open cup secured to the primer 15 and receiving a portion of the propellant charge 50. The distal end 22 of the casing 20 is folded on itself in order to close it and thus forms a folded closure 28.

Advantageously, the wadding 30 comprises a first portion 31 having an open end, and comprising a first recess 32 arranged to receive a determined volume of projectile(s), in this case shot 50, and a second portion 33 having an open end, and comprising a second recess 34 arranged to receive a determined volume of at least one propellant charge 60.

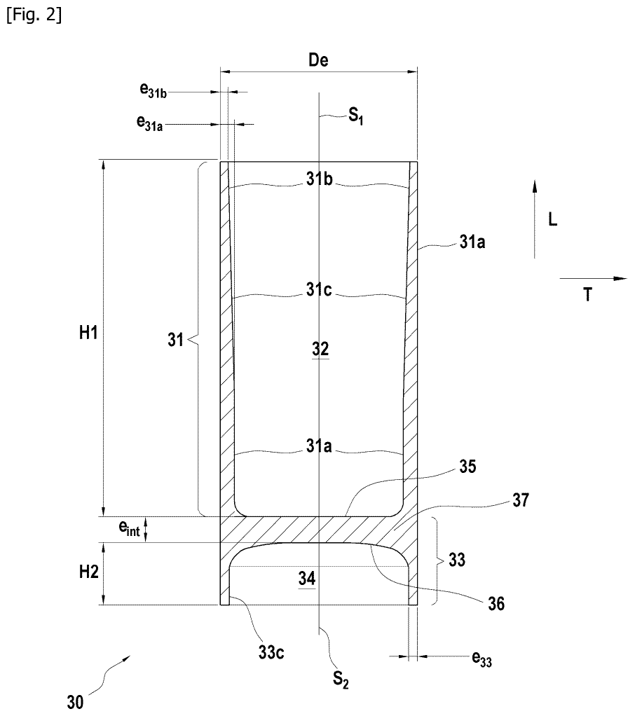

Advantageously, the wadding 30 is a single plastic piece. The wadding 30 is shown in detail in FIG. 2.

Advantageously, the height H1 of the first portion 31 is greater than or equal to 5 times, in particular greater than or equal to 6 times, the height H2 of the second portion 32. For example, H1 is approximately 33.00 mm and H2 is approximately 5.50 mm.

Advantageously, the bottom 35 of the first portion 31 is substantially flat.

Advantageously, the bottom 36 of the second portion 33 is substantially vaulted, i.e arched.

Advantageously, the thickness eint of the separation wall 37 separating the bottom 35 of the first portion 31 from the bottom 36 of the second portion 33 is greater than or equal to 2.00 mm, in particular greater than or equal to 2.50 mm+/−10%.

The first portion 31 comprises a proximal portion 31a and a distal portion 31b, and the thickness of the wall 31c, in particular of the radial wall 31c, of the first portion 31 is decreasing from its proximal portion 31a towards its distal portion 31b.

For example, the thickness e31a of the wall 31c of the first portion 31 in its proximal portion 31a is 1.16 mm, while the thickness e31b of the wall 31c of the first portion 31 in its distal portion 31b is 0.60 mm. The thickness of the wall 31c of the first portion 31 thus gradually decreases by substantially half, between its proximal portion 31a and its distal portion 31b.

Advantageously, the outer diameter De of the wadding 30 varies according to the calibre of the weapon, for example it may be 18 mm.

Advantageously, the thickness e33 of the wall 33c of the second portion 33 is substantially constant, for example of order 0.57 mm.

Advantageously, the wadding 30 comprises a longitudinal axis L along which the first and second portions (31, 33) extend, and a transverse axis T substantially perpendicular to the axis L.

Advantageously, the first portion 31 is a skirt comprising longitudinal slots (not visible), in particular comprising 2 to 6 longitudinal slots, in particular 4 longitudinal slots, distributed in a substantially equidistant manner. Preferably, one longitudinal slot opens at the open end of the distal portion 31 and extends from this over at least half the height H1, in particular over at least ⅔ of the height H1.

Advantageously, the access opening to the recess 32 of the first portion 31 is opposite the access opening to the recess 34 of the second portion 33.

Advantageously, the first and second portions (31, 33) are aligned along the longitudinal axis of the wadding 30.

Advantageously, the central axis of symmetry S1 of the first portion 31 is coincident with the central axis of symmetry S2 of the second portion 33, the central axis of symmetry S1 or S2 being parallel to the longitudinal axis L of the wadding 30.

Advantageously, the wadding 30 is produced by performing injection moulding step using a mould comprising a moulding imprint of said wadding 30 without longitudinal slots. Advantageously, a mixture comprising approximately 70% to 90% by mass of one or more polybutylene succinate polymer(s) (PBS), and approximately 6.5% to 30% by mass of calcium carbonate, in particular of a surface treated calcium carbonate, in particular of a calcium carbonate based primary compound, is extruded on a screw with a plurality of heating zones, for example 5 distinct heating zones, then the molten mixture is injected into the mould. A person skilled in the art knows to adjust the heating and injection parameters of the mixture in order to obtain an injection moulded part. The injected mixture is allowed to cool, then the injecting part is removed from the mould forming an intermediate wadding. Then the longitudinal slots are produced in the first portion in a finishing step but without adding one or more other parts to the intermediate wadding in order to finalise it and obtain the wadding according to the application, for example the wadding 30.

The precise dimensions indicated for the wadding and the cartridge are given here by way of non-limiting example for a determined volume of projectile, i.e approximately 32 g of shot and a determined volume of propellant charge. These dimensions vary as a function of the volume of projectile(s), for example 35 g or 28 g, of the volume of the propellant charge, and of the diameter or calibre of the weapon. However, these dimensions preferably remain in the same proportions in terms of the ratio of the heights H1 and H2, or even of the thickness of the separation wall or even of the variability of the thickness of the radial wall of the first portion of the wadding or of the constancy of the thickness of the radial wall of the second portion of the wadding.

### DESCRIPTION OF COMPARATIVE EXAMPLES

Test cartridges are prepared with 32 g of shot, the test cartridges correspond to that described in FIGS. 1 and 2 but without the degression of the thickness of the wall 31c, without the higher thickness eint (here, for the comparative examples, eint is approximately 1 mm), and without the curved bottom of the second portion 33. These structural parameters are only present in the tests according to the application, since they are applied in order to improve the performance of the wadding according to the application.

### Comparative Example 1

A wadding comprising 32 g of shot, with 100% by mass polybutylene succinate (PBS), in particular of grade FZ71 (PM/PB) marketed by Biochem Company Ltd, is injected in a single piece, 4 longitudinal slots are produced. The flexural modulus (measured using standard ISO 178) is approximately 630 MPa. The wadding is placed in a test cartridge as previously described, and test firings are performed. The firing velocity is on average 402.9 m/s, with a minimum of 389 m/s and a maximum of 433.5 m/s. The pressure exerted and measured is approximately 698.4 bar, with a minimum of 545.1 bar and a maximum of 948 bar. The standard deviation in velocity measured for V1 (m/s) is 14.5 m/s while that which the inventors seek to achieve is approximately 6 m/s at most, and the standard deviation in pressure P1 (bar) is 130 bar, while that which the inventors seek to achieve is approximately and at most 60 bar. Moreover, the wadding breaks/fragments on exiting the barrel of the weapon. The wadding does not therefore meet the standards decreed by the CIP.

### Comparative Example 2

The same test as for comparative example 1 is carried out with the only difference being that the polybutylene succinate is replaced by a more flexible grade FD92 (PM/PB) from BioChem Company Ltd, in particular having a flexural modulus (ISO 178) of approximately 250 MPa.

The standard deviation in velocity measured for V1 (m/s) is 8.6 m/s, and the standard deviation in pressure P1 (bar) is 57.5 bar. In addition, the wadding does not fragment on exiting the barrel of the weapon. Nevertheless, the standard deviation in the velocity V1 is still too high.

### Example According to the Application 1

The same test as for comparative example 2 is carried out with the difference that the injected mixture comprises 10% by mass of a primary compound comprising calcium carbonate, in particular comprising a surface treated calcium carbonate, such as Carbomax®Bio marketed by Cabamix®, and 90% by mass of grade PBS FD92 (PM/PB) used in the example.

The primary compound comprises 65% by mass of surface treated calcium carbonate, such as the calcium carbonate Smartfill® OM 55 marketed by OMYA®, in a mixture with approximately 35% by mass of a biodegradable aliphatic polyester, in particular PBS, preferably of the same grade as that tested and marketed by BioChem Company Ltd.

The standard deviation in pressure P1 (bar) remains at approximately 60 bar. The wadding does not fragment during firing in the barrel or on exiting the barrel. A reduction is seen in the standard deviation in the velocity of approximately 11% and a reduction in the injection time.

### Example According to the Application 2

The same test as for example 1 according to the application is carried out with the difference that the injected mixture comprises 20% by mass of said primary compound comprising calcium carbonate, in particular Carbomax®Bio marketed by Cabamix®, and 80% by mass of grade PBS FD92 (PM/PB) used in the comparative example 2.

The standard deviation in pressure P1 (bar) remains at approximately 60 bar. The wadding does not fragment during firing in the barrel or on exiting the barrel. A reduction is seen in the standard deviation in the velocity of approximately 22% and a very significant reduction in the injection time.

### Application Example 3

The same test as for example 1 according to the application is carried out with the difference that the injected mixture comprises 30% by mass of the calcium carbonate based primary compound, in particular Carbomax®Bio marketed by Cabamix®, and 70% by mass of grade PBS FD92 (PM/PB) used in comparative example 2. The standard deviation in pressure P1 (bar) remains at approximately 60 bar. The wadding does not fragment during firing in the barrel or on exiting the barrel. A standard deviation in the velocity is seen to be maintained at approximately 8 m/s (therefore no improvement compared with comparative example 2) and a reduction in the injection time.

### Comparative Example 3

The same test as for example 1 according to the application is carried out with the difference that the injected mixture comprises 40% by mass of the calcium carbonate based primary compound, in particular Carbomax®Bio marketed by Cabamix®, and 60% by mass of grade PBS FD92 (PM/PB) used in comparative example 2. The standard deviation in pressure P1 (bar) remains at approximately 60 bar. The wadding does not fragment during firing in the barrel or on exiting the barrel. A deterioration is seen in the standard deviation in velocity of approximately 10% compared with that obtained for comparative example 2, and a similar injection time to that of comparative example 2. There is therefore no improvement in ballistic performance of the wadding, nor in the injection process.

The biodegradability was measured on the wadding of example 2 according to the application by burying in soil in accordance with standard ISO 17556 dating from 2019. It is observed that 90% by mass of the wadding is biodegraded at the end of 151 days. The biodegradability was also measured on the wadding of example 2 according to the application in an aqueous medium in accordance with standard ISO 14851 dating from 2019. It is observed that 90% by mass of the wadding is biodegraded at the end of 84 days.

The wadding according to the application also offers improved and regular ballistic performance, while being biodegradable.

The wadding according to the application can also be obtained by a simple injection moulding method, for which the productivity is also improved concerning the duration of the injection reduced by approximately 22%. Moreover, the wadding according to the application does not require particular storage conditions, nor bagging in order to preserve it from the humidity.

1. An at least partially biodegradable wadding for a shot or bullet cartridge comprising a first portion having an open end and comprising a first recess arranged to receive a determined volume of projectile(s), and a second portion having an open end and comprising a second recess arranged to receive a determined volume of at least one propellant charge, wherein said wadding is a single plastic piece, wherein said wadding comprises one or more polymer(s) including one or more polybutylene succinate polymer(s), wherein said wadding comprises calcium carbonate, wherein the mass fraction of said one or more polymer(s) in said wadding is greater than or equal to 70%, wherein the mass fraction of calcium carbonate in said wadding is greater than or equal to 6.5%, and wherein the one or more polybutylene succinate polymer(s) is/are the majority by mass in said wadding.

2. The wadding according to claim 1, wherein the mass fraction of polymer(s) is greater than or equal to 70% and less than or equal to 90%.

3. The wadding according to claim 1, wherein the one or more polybutylene succinate polymer(s) represent at least 70% by mass of the wadding.

4. The wadding according to claim 1, wherein the calcium carbonate comprises calcium carbonate surface treated with a mixture of (poly) carboxylic acid(s) and/or one or more acid(s) anhydride(s) of said one or more (poly) carboxylic acids, and/or one or more salts of said one or more polycarboxylic acid(s) and/or one or more salts of said acid anhydride(s).

5. The wadding according to claim 1, wherein the wadding has a density ranging from 1.20 g/cm³ to 1.50 g/cm³.

6. The wadding according to claim 1, wherein the first portion is a skirt comprising longitudinal slots.

7. The wadding according to claim 1, wherein the first portion comprises a proximal portion and a distal portion, and wherein the thickness of the wall of the first portion is decreasing from its proximal portion towards its distal portion.

8. The wadding according to claim 1, wherein the wadding comprises a separation wall separating a bottom of the first portion of the wadding from a bottom of the second portion of the wadding, said separation wall having a thickness (eint) greater than or equal to 2.00 mm.

9. The wadding according to claim 1, wherein the height (H1) of the first portion is greater than or equal to 5 times the height (H2) of the second portion.

10. A shot or bullet cartridge comprising an at least partially biodegradable wadding for a shot or bullet cartridge according to claim 1.

11. A method for producing an at least partially biodegradable wadding for a shot or bullet cartridge wherein said method comprises the following steps:
i) preparing a mixture comprising one or more polymer(s) including one or more polybutylene succinate polymer(s), and further comprising a primary compound comprising calcium carbonate, the mass fraction of said one or more polymer(s) in said mixture is greater than or equal to 70%, the mass fraction of calcium carbonate in said mixture is greater than or equal to 6.5%, and the one or more polybutylene succinate polymer(s) is/are the majority by mass in said mixture;
ii) heating said mixture originating from step i) in a single moulding step for moulding a primary wadding for a shot or bullet cartridge with a mould set comprising an imprint of the primary wadding for a shot or bullet cartridge;
iii) recovering the primary wadding for a cartridge moulded in said mixture.

12. The method according to claim 11, wherein said method comprises further a step iv) of preparing one or more longitudinal slot(s) in the first portion of the primary wadding for a cartridge.

13. The method according to claim 11, wherein the one or more polybutylene succinate polymer(s) represent(s) at least 70% by mass of the mixture of step i).

14. The method according to claim 11, wherein the one or more polybutylene succinate polymer(s) has, or each have, a flexural modulus, measured using standard ISO 178:2019, less than or equal to 400 MPa.

15. The method according to claim 11, wherein the one or more polybutylene succinate polymer(s) has, or each have, a melt flow rate greater than or equal to 1 g/10 min and less than or equal to 10 g/10 min, measured at a temperature of 190° C., under a mass of 2.16 kg, and according to standard ISO 1133:2011.

16. The method according to claim 11, wherein the calcium carbonate of the primary compound comprises calcium carbonate surface treated with a mixture of (poly) carboxylic acid(s) and/or one or more acid(s) anhydride(s) of said one or more (poly) carboxylic acid(s), and/or one or more salt(s) of said one or more (poly) carboxylic acid(s) and/or one or more salt(s) of said one or more acid anhydride(s), wherein the primary compound comprises one or more biodegradable polymer(s) mixed with said calcium carbonate.

17. A method for producing a shot or bullet cartridge, wherein said method comprises the following steps:
providing a wadding for a cartridge and a cartridge comprising a casing, said casing comprising a primer;
placing a determined volume of a propellant charge inside the casing;
placing the wadding for a shot or bullet cartridge in the casing;
placing one or more projectiles in the casing;
crimping the cartridge; and
recovering the cartridge obtained.
